(19) United States
(12) Patent Application Publication
(10) Pub. No.: US 2006/0232733 A1
(43) Pub. Date: Oct. 19, 2006

(54) Liquid crystal display device

(75) Inventor: Minoru Shibazaki, Nishi-ku (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/556,334

(22) PCT Filed: Apr. 28, 2004
(86) PCT No.: PCT/IB04/50533

§ 371 Date: Nov. 10, 2005

(30) Foreign Application Priority Data
May 15, 2003 (JP) 2003-137510

(51) Int. Cl. G02F 1/1335

(52) U.S. Cl. 349/117

(57) ABSTRACT

An object of the invention is to provide a liquid crystal display device which can make full use of advantages of a parallel alignment type liquid crystal layer and obtain desired viewing angle characteristics. A liquid crystal display device 100 having a configuration wherein a linearly polarizing plate 11, a first retardation film 12, a second retardation film 13, a liquid crystal layer 14 and an optical reflective layer 15 are arranged in this order from a front side thereof. The linearly polarizing plate 11, and the first and second retardation films 12, 13 form means having a function of the right-hand or left-hand circular polarization. The first film 12 has a fixed retardation of substantially half of a wavelength of incident light. The liquid crystal layer 14 comprises a liquid crystal material of a parallel alignment type. The second film 13 and the liquid crystal layer 14 have a retardation of substantially quarter of a wavelength of incident light as a whole during black displaying operation of the device. In addition, for example, the following condition is fulfilled: an absorption axis of the linearly polarizing plate 11 and a slow axis of the first film 12 are deviated from their parallel position by a predetermined angle less than 45 degrees, and a slow axis of the second film 13 and an alignment direction of the liquid crystal layer 14 are substantially perpendicular to each other.

### BACKGROUND OF THE INVENTION

1. Field of the Invention

The invention relates to a liquid crystal display device. The invention, in particular, relates to a liquid crystal display device having a liquid crystal layer of a parallel alignment type.

2. Description of the Related Art

As optical modulation means, a reflective type liquid crystal display device has been proposed which has a liquid crystal layer of a parallel alignment type (for example, see Patent Document 1).

[Patent Document 1]

Japanese Patent Application Laid-Open No. 249126/99 (for example, paragraph numbers [0007] to [0013])

A liquid crystal optical device disclosed in this publication has a liquid crystal layer of a parallel alignment type, polarizing plates arranged on the respective front and rear sides of the layer, and a mirror electrode, and further has two kinds of retardation films arranged between the parallel alignment type liquid crystal layer and the polarizing plate, where values of retardations of the retardation films and the liquid crystal layer are optimized for the purpose of obtaining display with high brightness and high contrast in the device over a wide viewing angle range.

[Problems to be Solved by the Invention]

However, such optimization is also applicable to a structure using a HAN (Hybrid Aligned Nematic) type of liquid crystal layer or a bend alignment type of liquid crystal layer, not specified to a structure using the parallel alignment type of liquid crystal layer, nor to make full use of advantages of the parallel alignment type of liquid crystal layer.

The present inventor focused on a fact that a liquid crystal layer of a parallel alignment type or homogenous alignment type (hereinafter, collectively referred to as parallel alignment type) has liquid crystal molecules that are basically all arranged in parallel to and in the same direction as upper and lower substrate surfaces sandwiching the liquid crystal layer under a predetermined reference electric field (for example, zero electric field), in other words, the direction of the director of the liquid crystal molecules is substantially parallel to the substrate surfaces, whereby it is possible to recognize the average tilt angle of the liquid crystal molecules more accurately and readily than the other types. It also comes into focus that the parallel alignment type of liquid crystal layer does not need such an additional requirement for alignment control as a bias voltage required for the bend alignment type of liquid crystal layer, and is capable of adopting relatively simple alignment control. From these focuses, the inventor has reached a recognition that the very optimization specific to the parallel alignment type for making full use of advantages of the parallel alignment type would enable a desired viewing angle characteristic to be obtained most effectively in a display device using the parallel alignment type of liquid crystal layer.

In addition, while measures for obtaining a desired viewing angle characteristic are desired in a different approach from those as described in the above-mentioned patent document, optimization is expected in the case of using the parallel alignment type of liquid crystal layer in a liquid crystal display device other than the reflective type, for example, so-called transflective type that has been in practical use recently.

### SUMMARY OF THE INVENTION

(Object)

The present invention has been made in view of the forgoing, its object is to provide a liquid crystal display device which can make full use of advantages of a parallel alignment type of liquid crystal layer and obtain a desired viewing angle characteristic.

Another object of the invention is to provide a reflective type, transmissive type and transflective type of liquid crystal display devices which can make full use of advantages of the parallel alignment type of liquid crystal layer and obtain a desired viewing angle characteristic.

(Constitution)

In order to achieve the aforementioned objects, a liquid crystal display device according to an aspect of the invention has a configuration where a linearly polarizing plate, a first retardation film, a second retardation film, a liquid crystal layer and an optical reflective layer are arranged in this order from a front side thereof, in which the linearly polarizing plate, and the first and second retardation films form means having a function of the right-hand or left-hand circular polarization, the first retardation film has a fixed retardation of substantially half of a wavelength of incident light, the liquid crystal layer comprises a liquid crystal material of a parallel alignment type, the second retardation film and the liquid crystal layer have a retardation of substantially quarter of a wavelength of incident light as a whole during black displaying operation of the device, and any one of the following conditions is fulfilled:

(1) an absorption axis of the linearly polarizing plate and a slow axis of the first retardation film are deviated from their parallel position by a predetermined angle less than 45 degrees, and a slow axis of the second retardation film and an alignment direction of the liquid crystal layer are substantially perpendicular to each other;

(2) an absorption axis of the linearly polarizing plate and a slow axis of the first retardation film are deviated from their parallel position by the predetermined angle, and a slow axis of the second retardation film and an alignment direction of the liquid crystal layer are substantially parallel to each other;

(3) an absorption axis of the linearly polarizing plate and a slow axis of the first retardation film are deviated from their perpendicular position by the predetermined angle, and a slow axis of the second retardation film and an alignment direction of the liquid crystal layer are substantially perpendicular to each other; and

(4) an absorption axis of the linearly polarizing plate and a slow axis of the first retardation film are deviated from their perpendicular position by the predetermined angle, and a slow axis of the second retardation film and an alignment direction of the liquid crystal layer are substantially parallel to each other.

By doing so, it is possible to narrow viewing angle ranges that provide extremely low contrast ratios while distributing the ranges in point symmetry, and to relatively narrow viewing angle ranges with grayscale inversion while distributing the ranges in point symmetry.

In this aspect, the predetermined angle is within the range of angles enabling a value of 90 percent or more of the maximum contrast ratio to be obtained around the angle of reference which is an angle at which the maximum contrast ratio can be obtained in the liquid crystal display device, and preferably within the range of 21±10 degrees.

Also, in order to achieve the objects, a liquid crystal display device according to another aspect of the invention has a configuration where a front linearly polarizing plate, a first retardation film, a second retardation film, a liquid crystal layer, a third retardation film, a fourth retardation film and a rear linearly polarizing plate are arranged in this order from a front side thereof, in which the linearly polarizing plate, the first and second retardation films form means having one of the right-hand and left-hand circularly polarizing functions, and the third and fourth retardation films and the rear linearly polarizing plate form means having the other one of the right-hand and left-hand circularly polarizing functions, the first retardation film has a fixed retardation of substantially half of a wavelength of incident light, the liquid crystal layer comprises a parallel alignment type of liquid crystal material, the fourth retardation film has a fixed retardation of substantially half of a wavelength of incident light, and any one of the following conditions is fulfilled:

(1) an absorption axis of the front linearly polarizing plate and a slow axis of the first retardation film are deviated from their parallel position by a first predetermined angle less than 45 degrees, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by a second predetermined angle less than 45 degrees;

(2) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;

(3) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;

(4) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;

(5) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;

(6) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;

(7) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;

(8) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle;

(9) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;

(10) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;

(11) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;

(12) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle;

(13) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;

(14) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;

(15) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle; and

(16) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle,

if a relationship between the slow axis of the second retardation film and the alignment direction of the liquid crystal layer and a relationship between the alignment direction of the liquid crystal layer and the slow axis of the third retardation film both correspond to a substantially parallel or substantially perpendicular relation, the second retardation film, the liquid crystal layer and the third retardation film have a retardation of substantially half of a wavelength of incident light as a whole during black displaying operation of the device, whereas if a relationship between the slow axis of the second retardation film and the alignment direction of the liquid crystal layer and a relationship between the alignment direction of the liquid crystal layer and the slow axis of the third retardation film correspond to mutually different relations of one and the other of substantially parallel and substantially perpendicular relations, the second retardation film, the liquid crystal layer and the third retardation film have a retardation substantially equal to zero as a whole during black displaying operation of the device.

This means lead to such characteristics in which viewing angle ranges which provide extremely low contrast ratios are relatively narrow and viewing angle ranges with grayscale inversion are also relatively narrow.

In this aspect, it is preferable that the first and second predetermined angles are substantially equal to each other, and that the predetermined angle is within the range of angles enabling a value of 90 percent or more of the maximum contrast ratio to be obtained around the angle of reference which is an angle at which the maximum contrast ratio can be obtained in the liquid crystal display device, and more preferably within the range of 21±10 degrees.

Moreover, in the above-mentioned aspects, an optical reflective layer is placed between the liquid crystal layer and the third retardation film, where an area corresponding to the optical reflective layer is used as an optical reflective area within a pixel, and an area other than the optical reflective area is used as an optical transmissive area within the pixel, whereby the above-mentioned advantages can be expected in a transflective type liquid crystal display device.

Further, it is desirable that the third retardation film is a hybrid alignment nematic compensation film and that the second retardation film is a hybrid alignment nematic compensation film. The extremely excellent viewing angle characteristic is obtained in a liquid crystal display device where the hybrid alignment nematic compensation film has liquid crystal molecules having a tilt angle between 60 and 90 degrees at a side nearest the liquid crystal layer and liquid crystal molecules having a tilt angle of substantially zero degree at the farthest side from the liquid crystal layer. Furthermore, the viewing angle characteristic is drastically improved in a liquid crystal display device where during the black displaying operation of the device, an average tilt angle of molecules or refractive index ellipses of the second and third retardation films is substantially perpendicular to an average tilt angle of liquid crystal molecules or refractive index ellipses of the liquid crystal layer, and a sum of retardations of the second and third retardation films is substantially equal to a value of the retardation of the liquid crystal layer.

### BRIEF DESCRIPTION OF THE DRAWINGS

FIG. 1 is a cross sectional view showing a general structure of a liquid crystal display device according to one embodiment of the invention.

FIG. 2 is a schematic perspective view showing a construction of a parallel alignment type of liquid crystal layer applied to the invention.

FIG. 3 is a diagrammatic illustration showing combinations of optical axes and direction of different kinds of members in the liquid crystal display device of FIG. 1.

FIG. 4 is a table showing combinations of optical axes and direction of different kinds of members in the liquid crystal display device of FIG. 1 together with a total retardation value of the second retardation film and liquid crystal layer in black displaying.

FIG. 5 is a graph showing a viewing angle characteristic obtained in a liquid crystal display device configured in the combinations shown in FIGS. 3 and 4.

FIG. 6 is a schematic cross sectional view showing order of molecules of a hybrid alignment film applied to the second retardation film and/or the third retardation film.

FIG. 7 is a graph showing viewing angle characteristics of retardations in the case of a configuration using the hybrid alignment film of FIG. 6 and in the different case of comparison example.

FIG. 8 is a cross sectional view showing a general structure of a liquid crystal display device according to another embodiment of the invention.

FIG. 9 is a diagrammatic illustration showing combinations of optical axes and direction of different kinds of members in the liquid crystal display device of FIG. 8.

FIG. 10 is a table showing combinations of optical axes and direction of different kinds of members in the liquid crystal display device of FIG. 8 together with a total retardation value of the second retardation film, the liquid crystal layer and the third retardation film in black displaying.

FIG. 11 is a first graph showing a viewing angle characteristic obtained in the liquid crystal display device configured in the combinations shown in FIGS. 9 and 10.

FIG. 12 is a second graph showing a viewing angle characteristic obtained in the liquid crystal display device configured in the combinations shown in FIGS. 9 and 10.

FIG. 13 is a third graph showing a viewing angle characteristic obtained in the liquid crystal display device configured in the combinations shown in FIGS. 9 and 10.

FIG. 14 is a fourth graph showing a viewing angle characteristic obtained in a liquid crystal display device configured in the combinations shown in FIGS. 9 and 10.

FIG. 15 is a cross sectional view showing a general structure of a liquid crystal display device according to the other embodiment of the invention.

FIG. 16 is a diagrammatic illustration showing a configuration of a retardation film and a liquid crystal layer used in a liquid crystal display device according to a further embodiment of the invention.

### DESCRIPTION OF THE PREFERRED EMBODIMENT(S)

Now the above-mentioned aspects and other forms of the invention will be described in more detail by way of embodiments with reference to accompanying drawings.

### First Embodiment

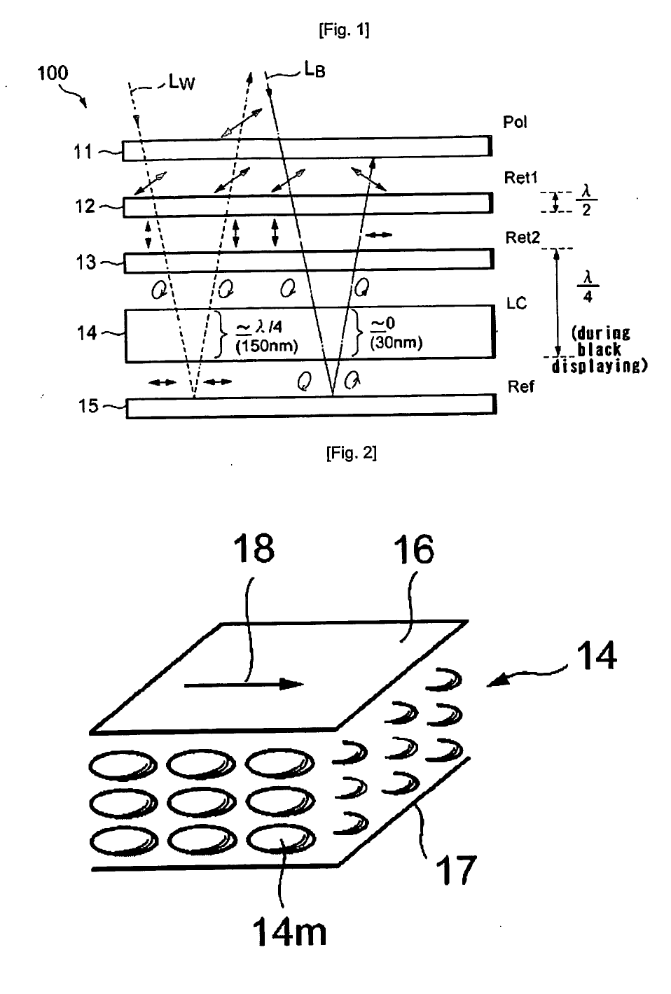

FIG. 1 schematically shows a cross sectional structure of a liquid crystal display device according to one embodiment of the invention.

The liquid crystal display device 100 is a reflective type liquid crystal display device, and has a configuration where a linearly polarizing plate (Pol) 11, a first retardation film (Ret1) 12 that is a half-wave plate, a second retardation film (Ret2) 13 that is a quarter-wave plate, a liquid crystal layer (LC) 14, and an optical reflective layer (Ref) 15 are arranged in this order from the front side that is the display screen side. The linearly polarizing plate 11, and the first and second retardation films 12, 13 form means having a function of the right-hand or left-hand circular polarization. It is noted that, for the sake of clarity of description, only principal structural elements are described herein, but other structural elements may be actually included in the display device 100.

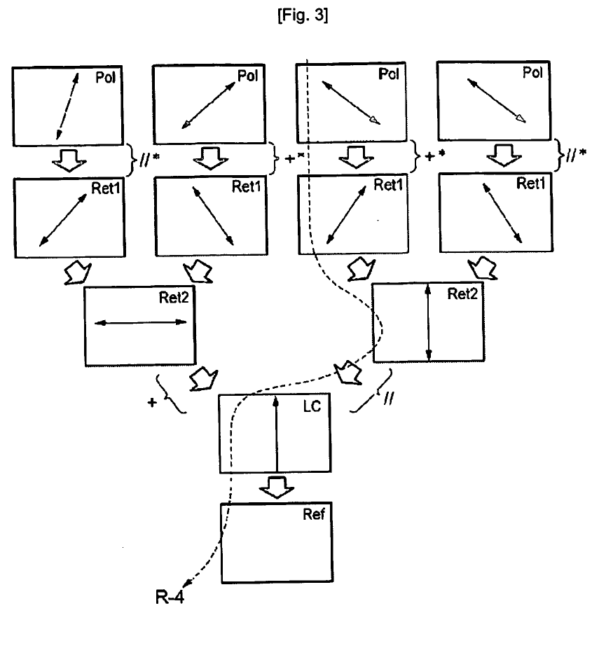

The first retardation film 12 has a fixed retardation of substantially half of wavelength λ of incident light, i.e., a value of λ/2. It is assumed that such incident light is light with the wavelength in a range of generally 380 nm to 780 nm. The liquid crystal layer 14 has a liquid crystal material of a parallel alignment type as described earlier. More specifically, the liquid crystal layer 14 has a molecular order as shown in FIG. 2, where all the liquid crystal molecules 14m are basically aligned along the rubbing direction 18 of upper and lower alignment layers 16 and 17 that determine the initial alignment of the liquid crystal molecules 14m. In other words, major axes of refractive index ellipsoids (indicatrixes) of the liquid crystal molecules 14m are all made parallel to the rubbing direction 18, i.e. the director of the liquid crystal molecules 14m is made parallel to the rubbing direction 18. It is noted that the rubbing direction 18 of the alignment layers 16 and 17 is herein set as a direction (initial) alignment direction) in which the liquid crystal layer 14 is aligned, but other methods than the rubbing may be used to specify an alignment direction.

Referring to FIG. 1 again, the second retardation film 13 and the liquid crystal layer 14 are intended to have a retardation of substantially quarter of the wavelength (λ/4) of incident light as a whole during black displaying operation (dark state) of the device 100.

As shown by a solid line L_{B} in FIG. 1, external light incident on the liquid crystal display device 100 first passes through the linearly polarizing plate 11 to be linearly polarized light, next passes through the first retardation film 12 while undergoing the retardation of λ/2, and becomes linearly polarized light in a changed predetermined direction. Then, the linearly polarized light enters the second retardation film 13 to be right-handed (or left-handed) elliptically polarized light, and is guided to the liquid crystal layer 14. During the black displaying operation (dark state), the retardation of the liquid crystal layer 14 is nearly zero (in this example, about 30 nm to obtain circularly polarized light), and right-handed (or left-handed) circularly polarized light reaches the reflective layer 15 (the above is about the first half of the path). On the second half of the path, the light from the liquid crystal layer 14 is reflected by the reflective layer 15, thereby becomes left-handed (or right-handed) circularly polarized light in a reverse direction, and enters the liquid crystal layer 14. The light passes through the liquid crystal layer 14 again, thereby becomes elliptically polarized light in a direction reverse to the direction of the elliptically polarized light incident on the liquid crystal layer 14 on the first half, and enters the second retardation film 13. The second retardation film 13 converts the reflected elliptically polarized light into linearly polarized light in a polarization direction perpendicular to the polarization direction of the linearly polarized light incident on the second retardation film 13 on the first half. When the linearly polarized light passes through the first retardation film 12, the light is provided with the retardation of λ/2, converted into linearly polarized light in a polarization direction perpendicular to the polarization direction of the linearly polarized light incident on the first retardation film 12 on the first half, and guided to the polarizing plate 11. Since the polarizing plate 11 has an absorption axis just parallel to the polarization direction of the linearly polarized light, the light entering from the first retardation film 12 is intercepted (absorbed) without coming out of a screen of the device 100, and thus the black displaying is presented.

Meanwhile, during white displaying operation (bright state), as shown by a broken line L_{W} in FIG. 1, right-handed (or left-handed) elliptically polarized light is incident on the liquid crystal layer 14 likewise. At this time, the liquid crystal layer 14 has a retardation of λ/4 (about 150 nm), and guides linearly polarized light in a predetermined polarization direction to the reflective layer 15 (the first half of the path is as described above). On the first half, the reflective layer 15 reflects the linearly polarized light, and returns the reflected light to the liquid crystal layer 14 with its polarization direction remained the same. The liquid crystal layer 14 converts the reflected linearly polarized light into right-handed (or left-handed) elliptically polarized light in the same direction as that of the elliptically polarized light incident on the layer 14 on the first half, and guides the elliptically polarized light to the second retardation film 13. The second retardation film 13 converts the reflected light into linearly polarized light in the same polarization direction as that of the linearly polarized light incident on the film 13 on the first half to guide it to the first retardation film 12. The first retardation film 12 also converts the light into linearly polarized light in the same polarization direction as that of the linearly polarized light incident on the film 12 on the first half to return it to the linearly polarizing plate 11. Since the polarizing plate 11 has an absorption axis perpendicular to the polarization direction of the linearly polarized light, the light entering from the first retardation film 12 passes through the plate and comes out of the screen of the device 100, and thus the white displaying is presented.

In the case of halftone displaying, the liquid crystal layer 14 and the second retardation film 13 provide the retardation corresponding to a halftone color or brightness to be displayed, and return to the first retardation film 12 elliptically polarized light with a vibration component corresponding to the retardation. In this way, the polarizing plate 11 receives a linearly polarized light component perpendicular to the absorption axis corresponding to the color or brightness, which comes out of the screen, and the halftone displaying is implemented.

This embodiment is further intended to have any of structural requirements as described below.

(R-1) First, the absorption axis of the linearly polarizing plate 11 and a slow axis of the first retardation film 12 are deviated from their parallel position by a predetermined angle less than 45 degrees, and a slow axis of the second retardation film 13 and an alignment direction of the liquid crystal layer 14 are substantially perpendicular to each other.

(R-2) Second, die absorption axis of the linearly polarizing plate 11 and a slow axis of the first retardation film 12 are deviated from their parallel position by the predetermined angle, and a slow axis of the second retardation film 13 and an alignment direction of the liquid crystal layer 14 are substantially parallel to each other.

(R-3) Third, the absorption axis of the linearly polarizing plate 11 and a slow axis of the first retardation film 12 are deviated from their perpendicular position by the predetermined angle, and a slow axis of the second retardation film 13 and an alignment direction of the liquid crystal layer 14 are substantially perpendicular to each other.

(R-4) Fourth, the absorption axis of the linearly polarizing plate 11 and a slow axis of the first retardation film 12 are deviated from their perpendicular position by the predetermined angle, and a slow axis of the second retardation film 13 and an alignment direction of the liquid crystal layer 14 are substantially parallel to each other.

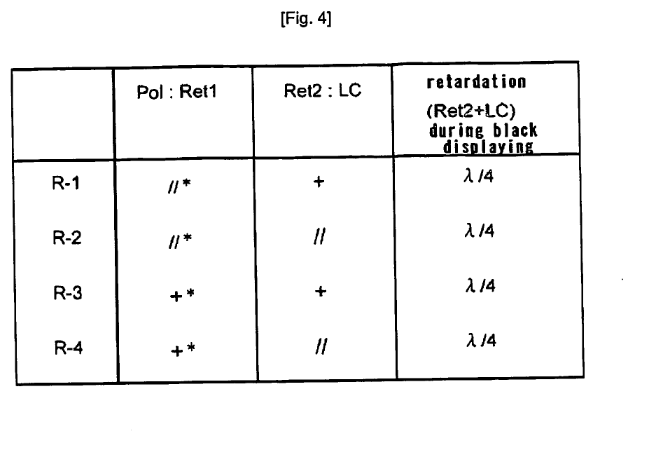

The aforementioned first to fourth relationships are summarily indicated in FIGS. 3 and 4.

FIG. 3 shows all the four relationships as described above at the same time, wherein the respective axes or directions are shown by arrows. In this figure, for the sake of clarity, members of the linearly polarizing plate 11, the first retardation film 12, the second retardation film 13, the liquid crystal layer 14 and the optical reflective layer 15 are indicated with Pol, Ret1, Ret2, LC and Ref, respectively.

In FIG. 3, starting with Pol on the top and following downward adjacent members let us find a correspondence of any of the first to fourth relationships. For example, the fourth relationship is given by a dotted arrow in FIG. 3, and with respect to the axes and directions as described above, the solid arrow drawn in each member visually leads to an arrangement taking a combination of Pol and Ret1 having an approximately perpendicular relation and Ret2 and LC having a substantially parallel relation. Further, with respect to the axes and directions of Pol and Ret1, symbol “//*” or “+*” shown in FIG. 3 respectively represents that Pol and Ret1 have an approximately parallel or perpendicular relation as described above. Furthermore, with respect to the axes and directions of Ret2 and LC, symbol “//” or “+” shown in FIG. 3 respectively represents that Ret2 and LC have a substantially parallel or perpendicular relation as described above.

A table of FIG. 4 further comprehensively shows the relationships together with values of retardations of the second retardation film (Ret2) and the liquid crystal layer (LC) during black displaying. Combinations of axes and directions of lines R-1 to R-4 respectively correspond to the first to fourth relationships. It is noted that vertical and horizontal directions viewed in FIG. 3 correspond to vertical and horizontal directions on a display screen of the display device configured according to this embodiment. Accordingly, for example, the right upward arrow drawn in the liquid crystal layer LC indicates a longitudinal direction from the bottom to the top on the screen. However, the direction of said arrow could be set at any other directions on the screen in addition to the longitudinal. For example, in consideration of obtained viewing angle characteristics, the direction of said arrow may be set at a direction of either diagonal line of the screen.

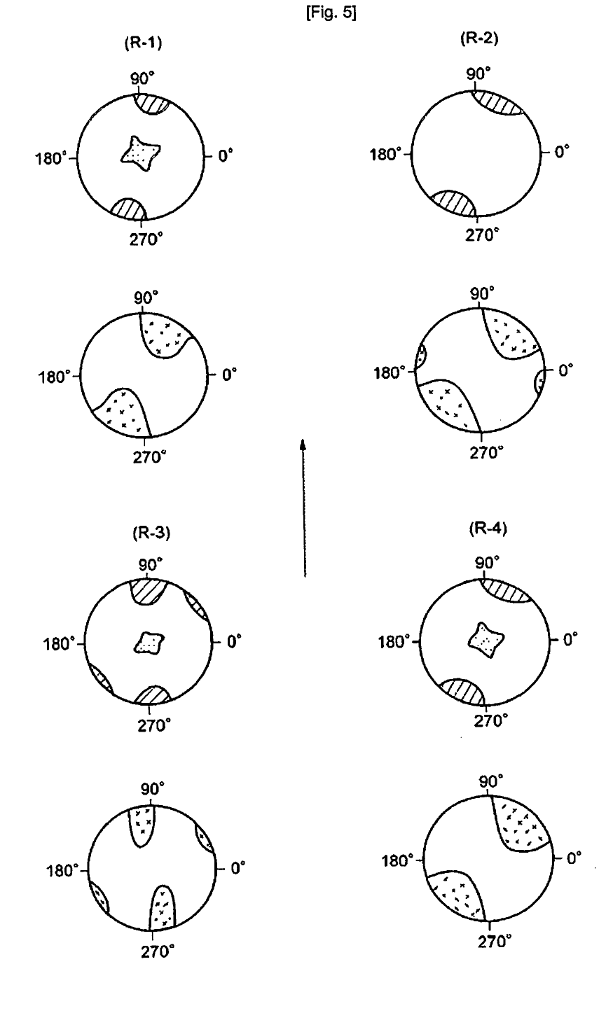

(R-1) to (R-4) in FIG. 5 show viewing angle characteristics of liquid crystal display devices to which the first to fourth relationships are applied, respectively. In each figure of (R-1) to (R-4), the upper graph shows a schematic view of an isocontrast characteristic, while the lower graph shows a schematic view of a grayscale inversion characteristic, and each graph indicates the characteristic of 360 degrees counter-clockwise starting with the rightmost end as 0 degree in the side-to-side direction. In this case, the alignment direction of the liquid crystal layer 14 is shown by an arrow in the center of FIG. 5.

The graph indicates with contour lines the contrast ratio and the degree of inversion of grayscale obtained in the case of turning the line of sight in all-angle directions starting with the center of the circle of the graph as a normal vision state of the screen. In other words, assuming that the direction of 0 degree corresponds to the rightmost end of the screen in the side-to-side direction, the values are obtained by starting with a state of looking straight at a front of the screen, and for example, with respect to the direction of 0 degree, turning the line of sight to the right in the side-to-side direction of the screen. Such acquisition of values is performed in directions of other angles, and from the values acquired in the all-angle directions, the contour lines of the values are obtained.

In the graph of the isocontrast characteristic, a range of presenting extremely high contrast ratios (100 or more) is shown by dots, while a range of presenting extremely low contrast ratios is shown by oblique lines. Further, in the graph of the grayscale inversion characteristic, ranges of causing grayscale inversion (in the case of 8 grayscale levels) are shown by crosses.

From FIG. 5, it is understood that the ranges of presenting extremely low contrast ratios are relatively small and distributed in point symmetry. Further, it is understood that the ranges of causing grayscale inversion are also small and distributed in point symmetry. Thus, according to this embodiment, it is possible to obtain excellent viewing angle characteristics.

The viewing angle characteristics as shown in FIG. 5 are of the case where the first retardation film 12 is a film used to form means for right-handed circular polarization. As a matter of course, the first retardation film 12 can be a film used to form means for left-handed circular polarization, as long as any one of the first to fourth requirements mentioned above is satisfied. When the first retardation film 12 is for left-handed circularly polarizing means, obtained viewing angle characteristics are symmetric with the characteristics of each graph about a reference line that is parallel to the arrow (the alignment direction of the liquid crystal layer 14) shown in the center in FIG. 5.

It is noted that, in the specific examples for obtaining the characteristics in FIG. 5, the predetermined angle in the first to fourth structural requirements is set at 21 degrees. However, a tolerance of this angle is defined as a range of angles at which a value of 90% or more of the maximum contrast ratio can be obtained around a reference angle which is an angle at which the maximum contrast ratio is obtained in the liquid crystal display device. Also in such a range with a tolerance, it is possible to obtain the viewing angle characteristic adequate for practical use and achieve the advantages specific to the invention. Such a tolerance may be set at a range of ±10 degrees of the predetermined angle. Further, excellent results can be expected when an acute angle formed by the slow axis of the first retardation film 12 and the slow axis of the second retardation film 13 is 60°±10°.

Moreover, it is suitable for the specific examples that the second retardation film 13 is a so-called NR film, i.e. a hybrid alignment nematic compensation film.

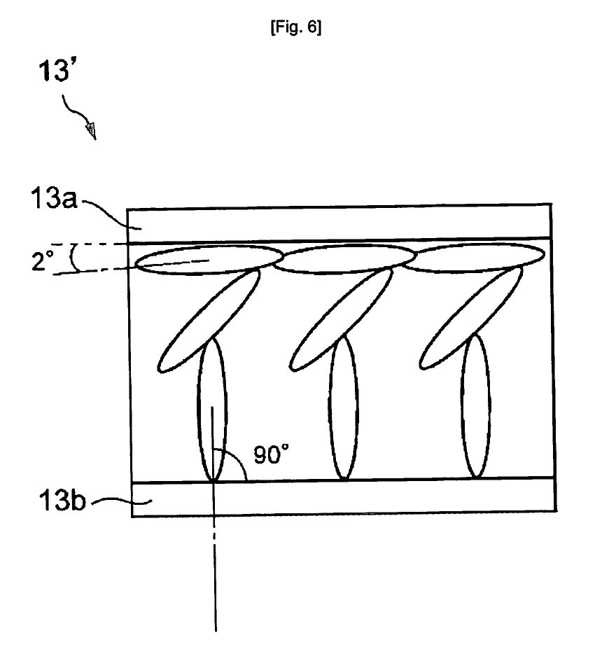

FIG. 6 schematically shows a cross sectional structure of the compensation film

In FIG. 6, the compensation film 13f has liquid crystal molecules having an improved hybrid alignment between upper and lower support layers 13a and 13b, where liquid crystal molecules at the side nearest the liquid crystal layer 14 have a pretilt angle ranging from 60° to 90°, preferably 90°, while liquid crystal molecules at the side farthest from the liquid crystal layer 14 have a pre-tilt angle of about 2°, preferably 0°.

Based on the constitution of such pre-tilt angles at both sides, matching is improved between the compensation film 13′ and parallel aligned molecules of the liquid crystal layer 14, whereby it is possible to accurately produce a retardation to be provided by the compensation film 13′ together with the parallel aligned molecules of the liquid crystal layer 14. In addition, it is possible to omit as appropriate the support layer 13b on the side of the liquid crystal layer 14.

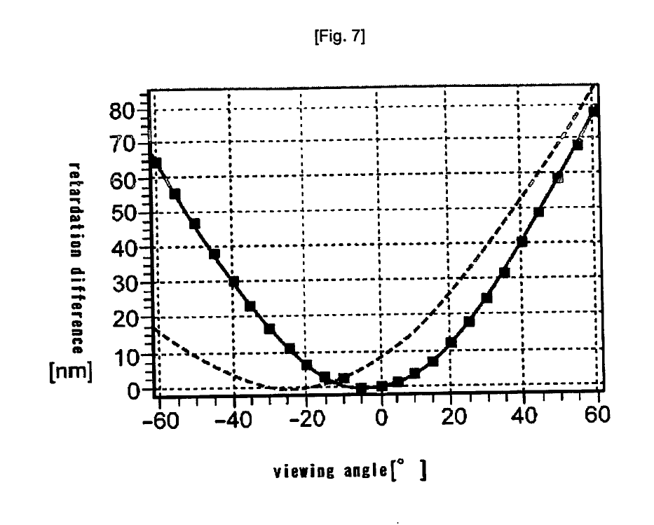

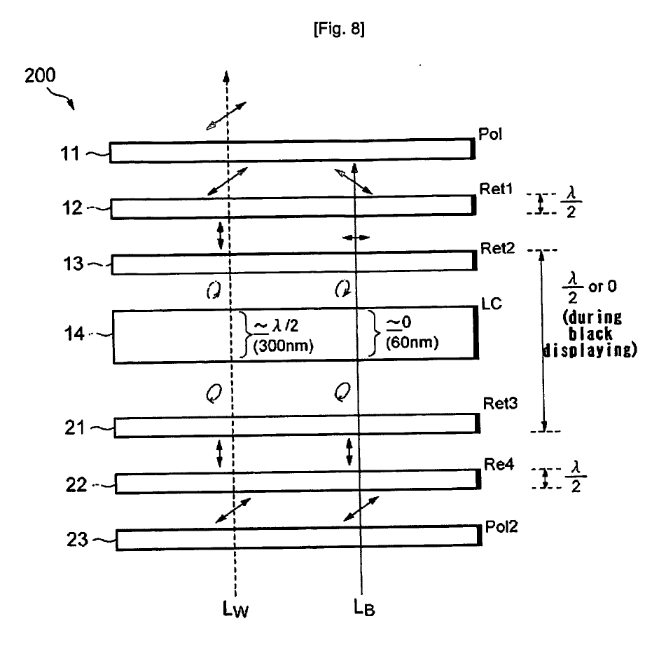

FIG. 7 is a graph showing viewing angle dependence of the retardation provided by the film 13′ and liquid crystal layer 14 in the case (see a dashed line) where the pre-tilt angle of liquid crystal molecules at the side nearest the liquid crystal layer 14 is 50° as a comparison example, and in the case (see a solid line) where such a pre-tilt angle is 90° as in the present specific example. It is noted that the graph shows characteristics in black displaying, and that the vertical axis shows a difference from the retardation (λ/4) obtained when viewed right from the front.

As can be seen from FIG. 7, with respect to the front-viewing state (0°) as a reference, variations in retardation are remarkably different between the right and the left in the comparison example, whereas the variations are almost symmetrical in the present example. The present example can thus preferably provide almost the same viewability when the screen is viewed from either the right or left. FIG. 7 also indicates that according to the present example, the retardation is almost λ/4 in the front-viewing state, and extremely dark displaying may be performed when looking at the front of the screen during the black displaying.

### Second Embodiment

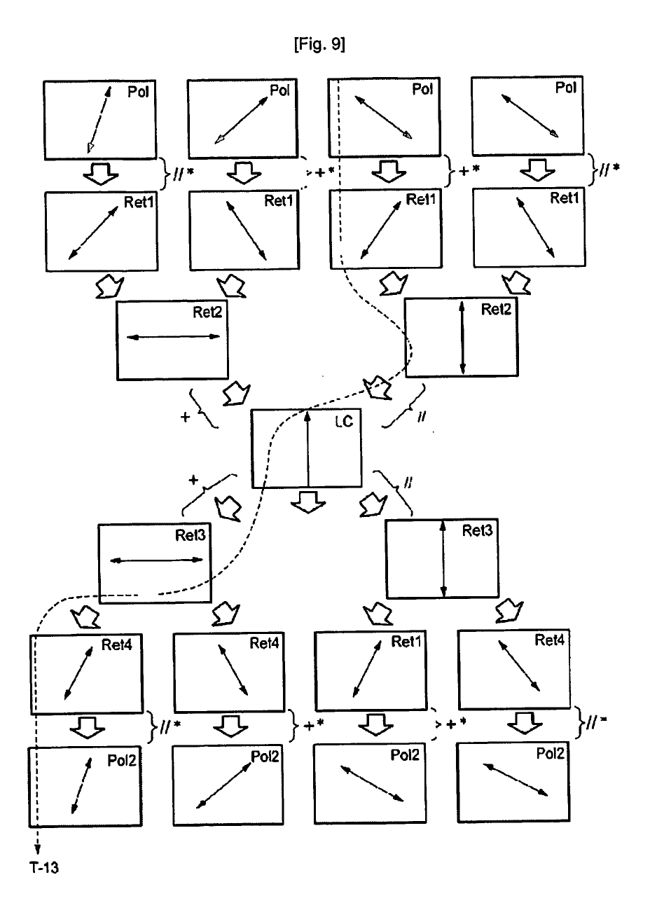

FIG. 8 schematically shows a cross sectional structure of a liquid crystal display device according to another embodiment of the invention.

The liquid crystal display device 200 is a transmissive type liquid crystal display device, and has a configuration where a linearly polarizing plate (Pol) 11, a first retardation film (Ret1) 12 that is a half-wave plate, a second retardation film (Ret2) 13 that is a quarter-wave plate, a liquid crystal layer (LC) 14, a third retardation film (Ret3) that is a quarter-wave plate, a fourth retardation film (Ret4) 22 that is a halfwave plate, and a rear linearly polarizing plate (Pol2) 23 are arranged in this order from the front side that is the display screen side. The linearly polarizing plate 11, the first and second retardation films 12, 13 form means having one of the right-hand and left-hand circularly polarizing functions, and the third and fourth retardation films 21, 22 and the rear linearly polarizing plate 23 form means having the other one of the right-hand and left-hand circularly polarizing functions. It is noted that portions equal to those in the earlier embodiment are assigned the same reference symbols, and detailed description thereof will be omitted, and also for the sake of clarity, only principal structural elements are cited.

As described earlier, the first retardation film 12 has the value of 72, and the liquid crystal layer 14 has the liquid crystal material of the parallel alignment type.

In this embodiment, substituting for the optical reflective layer 15 in the first Embodiment, the structure is provided with the third and fourth retardation films 21 and 22, and another linearly polarizing plate 23. The second retardation film 13, the liquid crystal layer 14 and the third retardation film 21 have a retardation of substantially half of the wavelength (λ/2) of incident light or substantially zero as a whole during black displaying operation (dark state) of the device 200. Which retardation to have will be apparent in the eater description. The fourth retardation film 22 has a fixed retardation of substantially half of the wavelength (λ/2) of incident light.

Light from backlight (not shown) is applied form the backside of the rear polarizing plate 23.

As shown by a solid line L_{B} in FIG. 8, the backlight light incident on the liquid crystal display device 200 first passes through the linearly polarizing plate 23 to be linearly polarized light, next passes through the fourth retardation film 22 with it being provided with a retardation of λ/2, and becomes linearly polarized light in a changed predetermined direction. Then, the linearly polarized light enters the third retardation film 21 to be right-handed (or left-handed) elliptically polarized light, and is guided to the liquid crystal layer 14. During the black displaying operation (dark state), the retardation of the liquid crystal layer 14 is nearly zero (however, in this example, about 60 nm to obtain elliptically polarized light with the same form as that of the incident light), and the elliptically polarized light incident on the liquid crystal layer 14 is guided to the second retardation film 13 with its direction remained the same as that of the incident elliptically polarized light The second retardation film 13 converts the transmitted elliptically polarized light into linearly polarized light in a predetermined direction. The linearly polarized light is provided with a retardation of λ/2 by the first retardation film 12, thereby the polarization direction being changed, and guided to the front polarizing plate 11. Since the polarizing plate 11 has an absorption axis just parallel to the polarization direction of the linearly polarized light, the light entering from the first retardation film 12 is intercepted (absorbed) without coming out of a screen of the device 200, and thus the black displaying is presented.

Meanwhile, during white displaying operation (bright state), as shown by a broken line L_{W} in FIG. 8, right-handed (or left-handed) elliptically polarized light is incident on the liquid crystal layer 14 likewise. At this time, the liquid crystal layer 14 has a retardation of λ/2 (about 300 nm), and guides to the second retardation film 13 elliptically polarized light in a direction reverse to the direction of the elliptically polarized light incident on the layer 14. The second retardation film 13 converts the transmitted light into linearly polarized light in a polarization direction perpendicular to that in the black displaying to guide it to the first retardation film 12. The light guided to the first retardation film 12 is provided with a retardation of λ/2, thereby the polarization direction being changed, and the resultant linear polarized light is guided to the front polarizing plate 11. Since the polarizing plate 11 has an absorption axis perpendicular to the polarization direction of the linearly polarized light, the light entering from the first retardation film 12 passes through the polarizing plate and comes out of the screen of the device 200, and thus the white displaying is presented.

In the case of halftone displaying, the liquid crystal layer 14 and the second and third retardation films 13 and 21 present the retardation corresponding to a halftone color or brightness to be displayed, and the first retardation film 12 is applied with elliptically polarized light having a vibration component corresponding to the retardation. In this way, the polarizing plate 11 receives a linearly polarized light component perpendicular to the absorption axis corresponding to the color or brightness, which comes out of the screen, and so the halftone displaying is implemented.

The present embodiment is intended to further have any one of structural requirements as described below. To choose one among the structural requirements determines a retardation that should be provided by the second retardation film 13, the liquid crystal layer 14 and the third retardation film 21 as a whole in the black displaying operation of the device 200.

(T-1) First, the absorption axis of the front linearly polarizing plate 11 and a slow axis of the first retardation film 12 are deviated from their parallel position by a first predetermined angle less than 45 degrees, a slow axis of the second retardation film 13 and an alignment direction of the liquid crystal layer 14 are substantially perpendicular to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their parallel position by a second predetermined angle less than 45 degrees, and the second retardation film 13, the liquid crystal layer 14 and the third retardation film 21 have a retardation of substantially half of the wavelength (λ/2) of incident light as a whole during black displaying operation of the device 200.

(T-2) Second, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation of substantially half of the wavelength (λ/2) of incident light as a whole during black displaying operation of the device 200.

(T-3) Third, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation substantially equal to zero (0) as a whole during black displaying operation of the device 200.

(T-4) Fourth, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation substantially equal to zero (0) as a whole during black displaying operation of the device 200.

(T-5) Fifth, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation substantially equal to zero (0) as a whole during black displaying operation of the device 200.

(T-6) Sixth, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation substantially equal to zero (0) as a whole during black displaying operation of the device 200.

(T-7) Seventh, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation of substantially half of the wavelength (λ/2) of incident light as a whole during black displaying operation of the device 200.

(T-8) Eighth, the absorption axis of the front linearly polarizing plate 11 and a slow axis of the first retardation film 12 are deviated from their parallel position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation of substantially half of the wavelength (λ/2) of incident light as a whole during black displaying operation of the device 200.

(T-9) Ninth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation of substantially half of the wavelength (λ/2) of incident light as a whole during black displaying operation of the device 200.

(T-10) Tenth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation of substantially half of the wavelength (λ/2) of incident light as a whole during black displaying operation of the device 200.

(T-11) Eleventh, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation substantially equal to zero (0) as a whole during black displaying operation of the device 200.

(T-12) Twelfth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially perpendicular to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation substantially equal to zero (0) as a whole during black displaying operation of the device 200.

(T-13) Thirteenth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their parallel position by the second predetermined angle, and the second retardation film 13, the liquid crystal layer 14 and the third retardation film 21 have a retardation substantially equal to zero (0) as a whole during black displaying operation of the device 200.

(T-14) Fourteenth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially perpendicular to each other, a slow axis of the fourth retardation film 22 and the absorption axis of the rear linearly polarizing plate 23 are deviated from their perpendicular position by the second predetermined angle, and the second retardation film 13, the liquid crystal layer 14 and the third retardation film 21 have a retardation substantially equal to zero (0) as a whole during black displaying operation of the device 200.

(T-15) Fifteenth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their parallel position by the second predetermined angle, the second retardation film 13, the liquid crystal layer 14 and the third retardation film 21 have a retardation of substantially half of the wavelength (λ/2) of incident light as a whole during black displaying operation of the device 200.

(T-16) Sixteenth, the absorption axis of the front linearly polarizing plate 11 and a slow axis of the first retardation film 12 are deviated from their perpendicular position by the first predetermined angle, a slow axis of the second retardation film 13 and an alignment direction of the liquid crystal layer 14 are substantially parallel to each other, the alignment direction of the liquid crystal layer 14 and a slow axis of the third retardation film 21 are substantially parallel to each other, a slow axis of the fourth retardation film 22 and the absorption axis of the rear linearly polarizing plate 23 are deviated from their perpendicular position by the second predetermined angle, the second retardation film 13, the liquid crystal layer 14 and the third retardation film 21 have a retardation of substantially half of the wavelength (λ/2) of incident light as a whole during black displaying operation of the device 200.

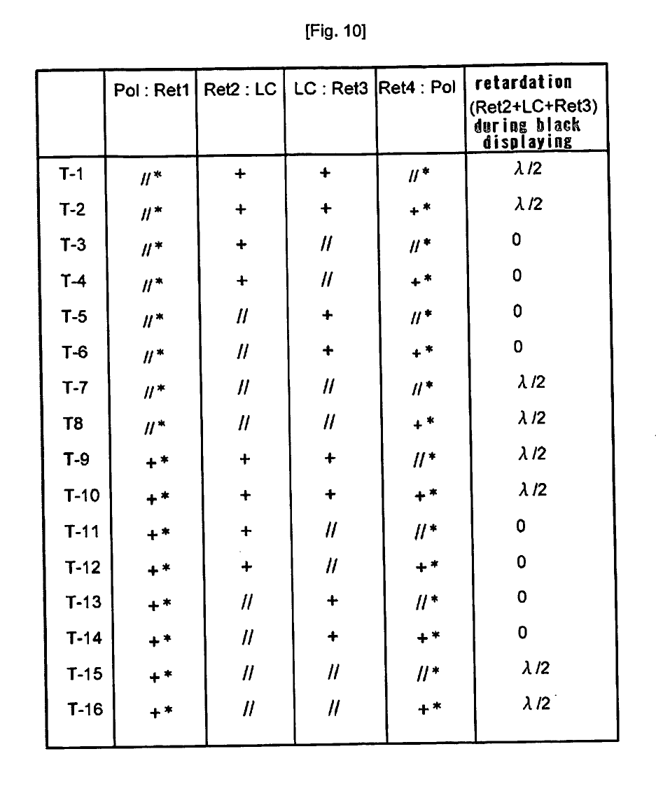

The first to sixteenth relationships are summarily indicated in FIGS. 9 and 10.

FIG. 9 shows all the sixteen relationships described above, where the above-mentioned various kinds of axes and directions are shown by arrows. For the sake of clarity, the members of the linearly polarizing plate 11, the first retardation film 12, the second retardation film 13 and the liquid crystal layer 14 are devoted by Pol, Ret1, Ret2 and LC, respectively and the members of the third retardation film 21, the fourth retardation film 22 and the second linearly polarizing plate 23 are denoted by Ret3, Ret4 and Pol2, respectively.

FIG. 9 is drawn in the same purport as the previous in FIG. 3. For example, the thirteenth relationship is given by a dotted arrow in FIG. 9, and with respect to the axes and directions described above, it is understood to correspond to a combination in which Pol and Ret1 have an approximately perpendicular relation, Ret2 and LC have a substantially parallel relation, LC and Ret3 have a substantially perpendicular relation, and Ret3 and Re4 have an approximately parallel relation. The table in FIG. 10 shows the combinations together with a total retardation value of the second retardation film (Ret2), the liquid crystal layer (LC) and the third retardation film during black displaying. Combinations of axes and directions of rows T-1 to T-16 respectively correspond to the first to sixteenth relationships. It is noted that up, down, right and left as viewed in FIG. 9 also correspond to up, down, right and left on a screen of the device respectively, but are not limited to this correspondence.

As is clearly found FIG. 10, the sum of retardations of the second retardation film (Ret2), the liquid crystal layer (LC) and the third retardation film (Ret3) during black displaying of the device 200 can be specified as follows. In other words, when a relationship between the slow axis of the second retardation film (Ret2) and the alignment direction of the liquid crystal layer (LC) and a relationship between the alignment direction of the liquid crystal layer (LC) and the slow axis of the third retardation film (Ret3) both correspond to a substantially parallel (//) or substantially perpendicular (+) relation, the sum of the retardations is substantially half of a wavelength of incident light. In contrast thereto, when the two relationships are different from each other, in other words, when one of the two relationships corresponds to one of substantially parallel (//) and substantially perpendicular (+) relations and the other corresponds to the other, the sum of retardations is substantially equal to zero.

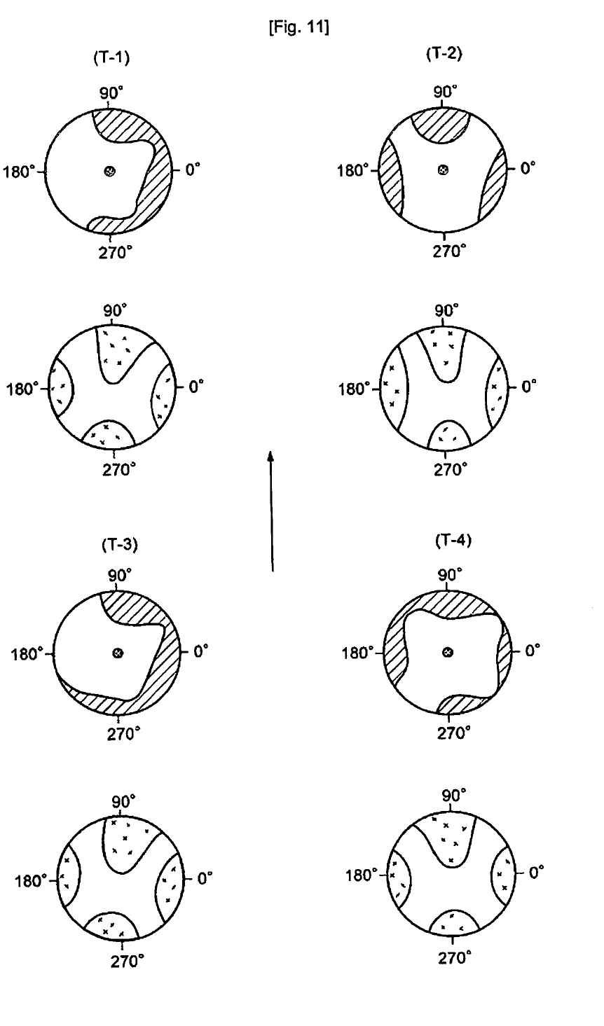

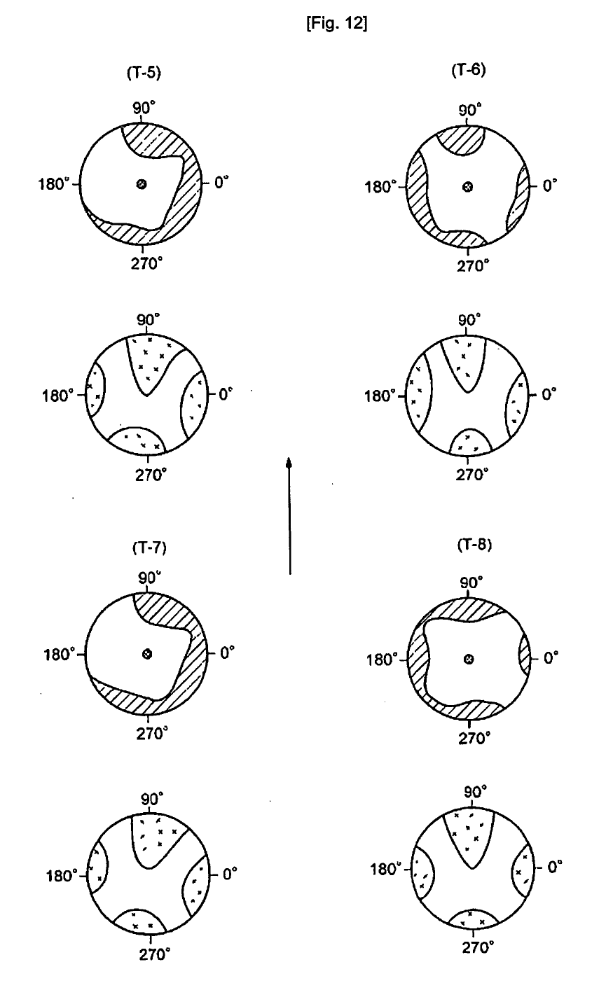

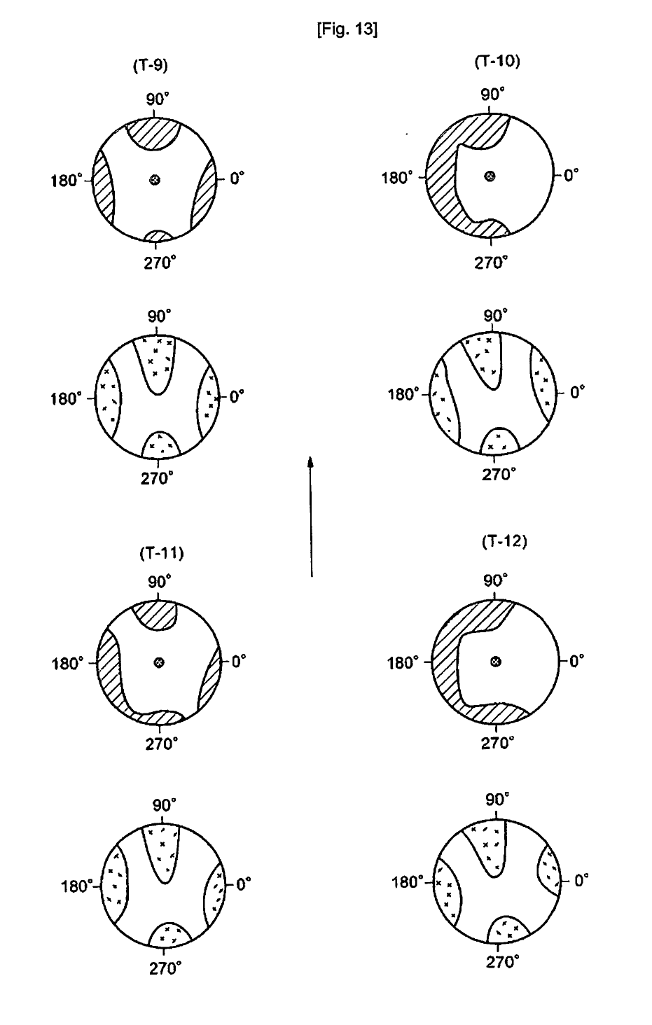

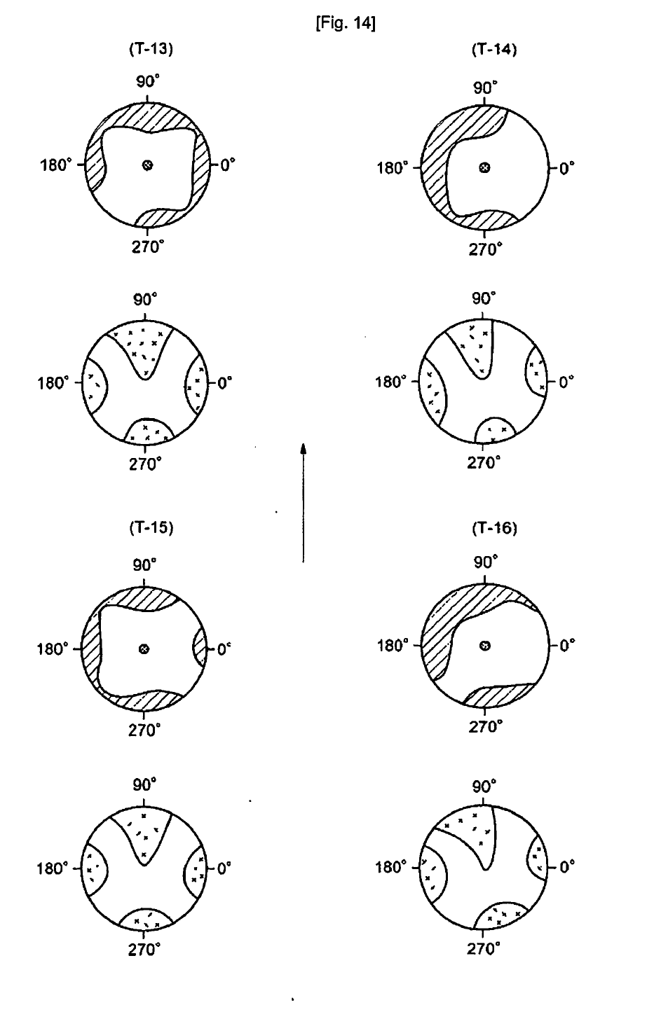

(T-1) to (T-16) in FIGS. 11 to 14 show viewing angle characteristics of liquid crystal display devices to which the first to sixteenth relationships are applied, respectively. Each graph of (T-1) to (T-16) is drawn in the same purport as the previous in FIG. 5.

From FIGS. 11 to 14, it is understood that ranges of presenting extremely low contrast ratios are relatively narrow, and that contrast drops only when the viewing angle is changed by considerably large degrees. In addition, it is understood that ranges of causing grayscale inversion are also relatively narrow, and that angle ranges of not causing grayscale inversion are adequate for practical use. Thus, according to this embodiment, it is possible to obtain excellent viewing angle characteristics.

The viewing angle characteristics as shown in FIGS. 11 to 14 are of the case where the first retardation film 12 is a film used to form means for right-handed circular polarization. As a matter of course, the first retardation film 12 can be a film used to form means for left-handed circular polarization, as long as any one of the first to sixteenth requirements is satisfied. When the first retardation film 12 is for left-handed circularly polarizing means, obtained viewing angle characteristics are symmetric with the characteristics of each graph about a reference line that is parallel to the arrow (the alignment direction of the liquid crystal layer 14) shown in the center in each of FIGS. 11 to 14.

It is noted that, in the specific examples for obtaining the characteristics in FIGS. 11 to 14, the first predetermined angle and the second predetermined angle in the first to sixteenth structural requirements are each set at 21 degrees. The two angels may be set at other values in an allowable range, or set at different values from each other, but are preferably set to be equal. On the other hand, the allowable range of this angle may be defined as a range of angles enabling a value of 90% or more of the maximum contrast ratio to be obtained around a reference angle, which is an angle at which the maximum contrast ratio is obtained in the liquid crystal display device. Also in such an allowable range, it is possible to obtain the viewing angle characteristic adequate for practical use and achieve the advantages inherent in the invention. The allowable range is set as a range of ±10 degrees of the predetermined angle. Further, excellent results can be expected when an acute angle formed by the slow axis of the first retardation film 12 and the slow axis of the second retardation film 13 is 60°±10°, and an acute angle formed by the slow axis of the third retardation film 21 and the slow axis of the fourth retardation film 22 is 60°±10°.

Moreover, it is suitable in the specific examples to use a so-called NR film, i.e. a hybrid alignment nematic compensation film as the second retardation film 13 or the third retardation film 21. It is preferable that both films are hybrid alignment nematic compensation films. It is more preferable that the compensation film has the same structure as shown in FIG. 6. The technical purport of such a structure is the same as described above, and so descriptions thereof are omitted herein.

### Third Embodiment

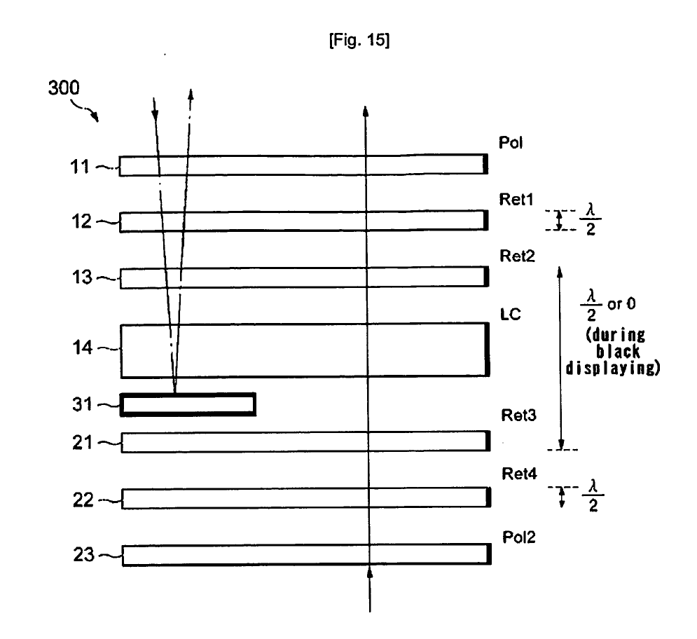

FIG. 15 schematically shows a cross sectional structure of a liquid crystal display device according to the other embodiment of the invention.

The liquid crystal display device 300 is a transflective type liquid crystal display device, and basically has the structure having an optical reflective layer 31 arranged between the liquid crystal layer 14 and the third retardation film 21 in the structure of the transmissive type liquid crystal display device 200 as described above. In the optical reflective layer 31, basically within each pixel, a reflective area is formed, and the other area is formed as a transmissive area The optical reflective layer 31 may be formed to also serve as a pixel electrode.

The other structural aspect and behavior of incident light can be described in the same way as in the reflective type liquid crystal display device 100 and the transmissive type liquid crystal display device 200 respectively described in First and Second Embodiments. In other words, the behavior of light reflected by the optical reflective layer 31 is the same as in the reflective type liquid crystal display device 100, and the behavior of light from the backlight passing through a portion other than the layer 31 i.e., the transmissive area is the same as in the transmissive type liquid crystal display device 200.

According to this embodiment, it is possible to expect the same effects and advantages as presented in the First and Second Embodiments as described above.

### Fourth Embodiment

This embodiment leads to a structure using the second retardation film 13 and the third retardation film 21, i.e. transmissive type and transflective type of liquid crystal display devices, and further provides the films with additional requirements to obtain a further optimized structure.

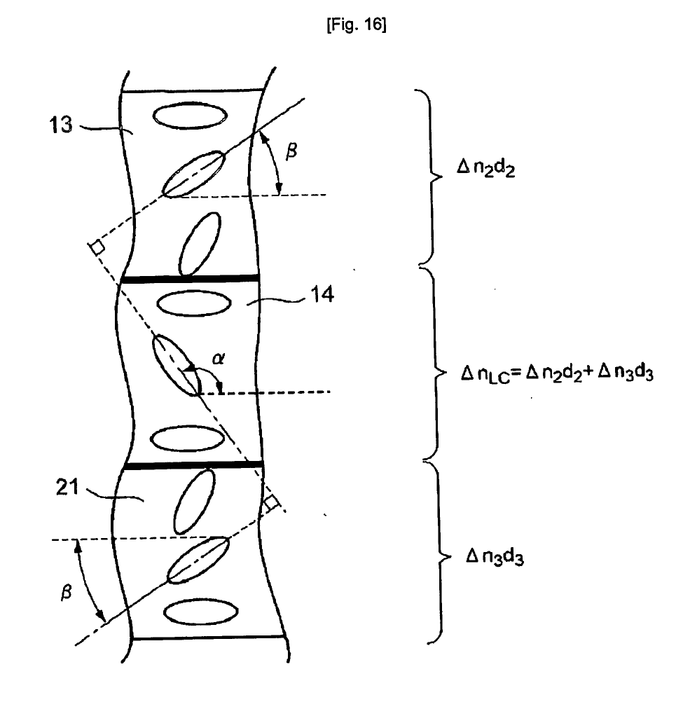

In the foregoing, it has been described that the hybrid alignment nematic compensation films is preferably applied to the second and third retardation films 13 and 21 but may be applied or may not be applied to them. In this embodiment, such a type of film is supposed to be selected for the second and third retardation films 13 and 21. As shown in the schematic view in FIG. 16, in black displaying operation (when the electric field is applied to the liquid crystal layer) of the device 200 or 300, the average tilt angle β of molecules or indicatrix of the second retardation film 12 and the third retardation film 21 is substantially perpendicular to the average tilt angle α of liquid crystal molecules or indicatrix of the liquid crystal layer 14. Further, the sum of retardation Δn₂d₂ of the second retardation film 13 and retardation Δn₃d₃ of the third retardation film 21 is made substantially equal to the retardation value Δn_{LC}d_{LC} of the liquid crystal layer 14. Namely, Δn_{LC}d_{LC}=Δn₂d₂+Δn₃d₃

Actually, the average tilt angle α of the liquid crystal layer 14 may be set at a range of 70° to 80°, and the average tilt angle β of the retardation film may be set at approximately 20°. Further, each of values of retardations Δn₂d₂ and Δn₃d₃ can be set at 0.231×0.55 μm, and a value of retardation Δn_{LC}d_{LC} can be set at about 250 nm.

In this way, it is possible to considerably increase a viewing angle range of providing sufficiently high contrast ratios while keeping a viewing angle range of not causing grayscale inversion adequate for practical use. Thus, according to this embodiment, it is possible to obtain excellent viewing angle characteristics. Especially in this embodiment, since the liquid crystal layer 14 is of the parallel alignment type, it is possible to beforehand recognize the average tilt angle a accurately. So, by combining the liquid crystal layer with the hybrid alignment nematic compensation film as described above, it is easy to obtain desired characteristics, leading to a preferable aspect.

In the foregoing, the embodied forms of the present invention have been described, but they may be modified in a variety of ways. Further, the invention is capable of being carried into practice with the liquid crystal display device given some additional structural element. Furthermore, it should be noted that technical features specific to the invention are expressed using terms such as “slow axish, “alignment directionh, “perpendicularh and “parallelh, but they may be expressed using other terms, so that the invention is directed to the true sense of the technical features translated from the terms.

The invention is not necessarily limited to the above-mentioned embodiments, and it would be apparent that those skilled in the art could derive various modifications thereof without departing from the scope of claims.

### INDUSTRIAL APPLICABILITY

The invention is capable of being used in a liquid crystal display device using the parallel alignment type of liquid crystal layer.

### EXPLANATION OF SYMBOLS

100 . . . liquid crystal display device

11 . . . linearly polarizing plate

12 . . . first retardation film

13 . . . second retardation film

14 . . . liquid crystal layer

15 . . . optical reflective layer

14m . . . liquid crystal molecule

16, 17 . . . alignment layer

18 rubbing direction

13′ . . . hybrid alignment nematic compensation film

13a, 13b . . . support layer

200 . . . liquid crystal display device

21 . . . third retardation film

22 . . . fourth retardation film

23 . . . linearly polarizing plate

1. A liquid crystal display device having a configuration wherein a linearly polarizing plate, a first retardation film, a second retardation film, a liquid crystal layer and an optical reflective layer are arranged in this order from a front side thereof, wherein:
the linearly polarizing plate, and the first and second retardation films form means having a function of the right-hand or left-hand circular polarization;
the first retardation film has a fixed retardation of substantially half of a wavelength of incident light;
the liquid crystal layer comprises a liquid crystal material of a parallel alignment type;
the second retardation film and the liquid crystal layer have a retardation of substantially quarter of a wavelength of incident light as a whole during black displaying operation of the device; and
any one of the following conditions is fulfilled:
(1) an absorption axis of the linearly polarizing plate and a slow axis of the first retardation film are deviated from their parallel position by a predetermined angle less than 45 degrees, and a slow axis of the second retardation film and an alignment direction of the liquid crystal layer are substantially perpendicular to each other;
(2) an absorption axis of the linearly polarizing plate and a slow axis of the first retardation film are deviated from their parallel position by the predetermined angle, and a slow axis of the second retardation film and an alignment direction of the liquid crystal layer are substantially parallel to each other;
(3) an absorption axis of the linearly polarizing plate and a slow axis of the first retardation film are deviated from their perpendicular position by the predetermined angle, and a slow axis of the second retardation film and an alignment direction of the liquid crystal layer are substantially perpendicular to each other; and
(4) an absorption axis of the linearly polarizing plate and a slow axis of the first retardation film are deviated from their perpendicular position by the predetermined angle, and a slow axis of the second retardation film and an alignment direction of the liquid crystal layer are substantially parallel to each other.

2. A liquid crystal display device as defined in claim 1, characterized in that the predetermined angle is within the range of angles in which when an angle of reference is an angle at which the maximum contrast ratio can be obtained in the liquid crystal display device, a value of 90 percent or more of the maximum contrast ratio is obtained around the angle of reference.

3. A liquid crystal display device as defined in claim 1, characterized in that the predetermined angle is within the range of 21±10 degrees.

4. A liquid crystal display device having a configuration in which a front linearly polarizing plate, a first retardation film, a second retardation film, a liquid crystal layer, a third retardation film, a fourth retardation film, and a rear linearly polarizing plate are arranged in this order from a front side thereof, wherein:
the linearly polarizing plate, the first and second retardation films form means having one of the right-hand and left-hand circularly polarizing functions, and the third and fourth retardation films and the rear linearly polarizing plate form means having the other one of the right-hand and left-hand circularly polarizing functions;
the first retardation film has a fixed retardation of substantially half of a wavelength of incident light;
the liquid crystal layer comprises a parallel alignment type of liquid crystal material; and
the fourth retardation film has a fixed retardation of substantially half of a wavelength of incident light;
any one of the following conditions is fulfilled:
(1) an absorption axis of the front linearly polarizing plate and a slow axis of the first retardation film are deviated from their parallel position by a first predetermined angle less than 45 degrees, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by a second predetermined angle less than 45 degrees;
(2) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;
(3) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;
(4) an absorption axis of the front linearly polarizing plate and a slow axis of the first retardation film are deviated from their parallel position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;
(5) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;
(6) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;
(7) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;
(8) an absorption axis of the front linearly polarizing plate and a slow axis of the first retardation film are deviated from their parallel position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle;
(9) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;
(10) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;
(11) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle;
(12) an absorption axis of the front linearly polarizing plate and a slow axis of the first retardation film are deviated from their perpendicular position by the first predetermined angle, and a slow axis of the second retardation film and an alignment direction of the liquid crystal layer are substantially perpendicular to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle;
(13) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their parallel position by the second predetermined angle;
(14) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially perpendicular to each other, and a slow axis of the fourth retardation film and an absorption axis of the rear linearly polarizing plate are deviated from their perpendicular position by the second predetermined angle;
(15) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their parallel position by the second predetermined angle; and
(16) an absorption axis of the front linearly polarizing plate and a slow axis of the first retardation film are deviated from their perpendicular position by the first predetermined angle, and a slow axis of the second retardation film and an alignment direction of the liquid crystal layer are substantially parallel to each other, the alignment direction of the liquid crystal layer and a slow axis of the third retardation film are substantially parallel to each other, and a slow axis of the fourth retardation film and an absorption axis of the rear linearly polarizing plate are deviated from their perpendicular position by the second predetermined angle,
if a relationship between the slow axis of the second retardation film and the alignment direction of the liquid crystal layer and a relationship between the alignment direction of the liquid crystal layer and the slow axis of the third retardation film both correspond to a substantially parallel or substantially perpendicular relation, the second retardation film, the liquid crystal layer and the third retardation film have a retardation of substantially half of a wavelength of incident light as a whole during black displaying operation of the device, whereas if a relationship between the slow axis of the second retardation film and the alignment direction of the liquid crystal layer and a relationship between the alignment direction of the liquid crystal layer and the slow axis of the third retardation film correspond to mutually different relations of one and the other of substantially parallel and substantially perpendicular relations, the second retardation film, the liquid crystal layer and the third retardation film have a retardation substantially equal to zero as a whole during black displaying operation of the device.

5. A liquid crystal display device as defined in claim 4, characterized in that the first and second predetermined angles are substantially equal to each other.

6. A liquid crystal display device as defined in claim 4, characterized in that the predetermined angle is within the range of angles in which when an angle of reference is an angle at which the maximum contrast ratio can be obtained in the liquid crystal display device, a value of 90 percent or more of the maximum contrast ratio is obtained around the angle of reference.

7. A liquid crystal display device as defined in claim 4, characterized in that the predetermined angle is within the range of 21±10 degrees.

8. A liquid crystal display device as defined in claim 4, further comprising an optical reflective layer placed between the liquid crystal layer and the third retardation film, wherein an area corresponding to the optical reflective layer is used as an optical reflective area within a pixel, and an area other than the optical reflective area is used as an optical transmissive area within the pixel.

9. A liquid crystal display device as defined in claim 4, characterized in that the third retardation film is a hybrid alignment nematic compensation film.

10. A liquid crystal display device as defined in claim 1, characterized in that the second retardation film is a hybrid alignment nematic compensation film.

11. A liquid crystal display device as defined in claim 9, wherein the hybrid alignment nematic compensation film has liquid crystal molecules having a tilt angle between 60 and 90 degrees at a side nearest the liquid crystal layer and liquid crystal molecules having a tilt angle of substantially zero degree at the farthest side from the liquid crystal layer.

12. A liquid crystal display device as defined in claim 9, wherein during the black displaying operation of the device,
an average tilt angle of molecules or refractive index ellipses of the second and third retardation films is substantially perpendicular to an average tilt angle of liquid crystal molecules or refractive index ellipses of the liquid crystal layer,
a sum of retardations of the second and third retardation films is substantially equal to a value of the retardation of the liquid crystal layer.
